(19) United States
(12) Patent Application Publication
(10) Pub. No.: US 2012/0244949 A1
(43) Pub. Date: Sep. 27, 2012

(54) Interactivity Platform for Multimedia Transmission, Broadcast TV, Cable, Radio, and Live Events

(76) Inventor: Peter Matthew Redling, Greensboro, NC (US)

(21) Appl. No.: 13/430,423

(22) Filed: Mar. 26, 2012

Related U.S. Application Data
(60) Provisional application No. 61/465,785, filed on Mar. 24, 2011.

(51) Int. Cl. A63F 9/24

(52) U.S. Cl. 463/42

(57) ABSTRACT

The present invention relates generally to an interactivity platform for multimedia transmission, broadcast TV, cable, radio, and live events. More particularly, the invention encompasses an interactive program between a provider and a participant utilizing an event. The present invention is also directed to an interactive program between an event provider and a participant utilizing an event including the participant's input in response to a challenge from the event provider. The present invention is also directed to a novel reward and compensation system for both the event provider and the participant. The invention also allows the participants to interact with the event provider as an individual or as a group or posse.

### CROSS-REFERENCE TO RELATED APPLICATION

The instant patent application claims priority to and the benefit of pending U.S. Provisional Patent Application Ser. No. 61/465,785, filed on Mar. 24, 2011, titled “Interactivity Platform For Multimedia Transmission, Broadcast TV, Cable, Radio And Live Events,” the entire disclosure of which provisional application is incorporated herein by reference.

### FIELD OF THE INVENTION

The present invention relates generally to a interactivity platform for multimedia transmission, broadcast TV, cable, radio, and live events. More particularly, the invention encompasses an interactive program between a provider and a participant utilizing an event. The present invention is also directed to an interactive program between an event provider and a participant utilizing an event including the participant's input in response to a challenge from the event provider. The present invention is also directed to a novel reward and compensation system for both the event provider and the participant. The invention also allows the participants to interact with the event provider as an individual or as a group or posse.

### BACKGROUND INFORMATION

Various efforts have been done in the past to improve on the experience and interaction between an advertiser or provider and a customer or participant, but they have had limited success.

U.S. Pat. No. 6,944,880 (Paul G. Allen), the entire disclosure of which is incorporated herein by reference, discloses a remote control for an interactive television system includes an integrated microphone and a wireless transmitter for transmitting audio information generated by the microphone to the interactive television system. A set top box for the interactive television system includes a wireless receiver for receiving the audio information and a converter for transforming the audio information into a network-compatible audio stream for transmission to a network.

U.S. Pat. No. 7,603,321 (Amy R. Gurvey), the entire disclosure of which is incorporated herein by reference, provides a method and system of electronically associating one or any combination of the production, balancing, editing, transmission, distribution and sale of live event “Recordings” with the sale of a “ticket” [defined to include any entrance payment/receipt, (tournament) entrance fee or logged placed bet] to or during the event, such that both or either of a ticket purchaser and/or non-ticket purchaser are able to automatically acquire a Recording or participate in interactive offerings related to the event by means of [optional] authenticated retrieval systems at a terminal device when connected to the Internet or wireless network. A method for electronically converting a balanced audience feed to the value for optimal Recording balance is also disclosed for optional integration. Distribution and/or retrieval of a Recording by patrons, non-attendee purchasers and/or licensees may occur when the Recording is embodied in a fixed medium of expression and/or when the Recording is in digital or other encoded format.

U.S. Pat. No. 7,890,988 (Erik G. Urdang, et al.), the entire disclosure of which is incorporated herein by reference, discloses delivering an entertainment program over a communications network, e.g., a cable TV network, interactive application data for realizing interactive features in the entertainment program are interjected into the program stream carrying the entertainment program on an as needed basis. Because the entire channel bandwidth is temporarily dedicated for transmission of the interactive application data, whose amount is relatively small compared with that of the video and audio data of the programming content, the interactive application data when transmitted appears as a short “burst,” causing a virtually unnoticeable interruption in the programming content delivery.

U.S. Pat. No. 7,930,721 (Eric Leslie Hernes), the entire disclosure of which is incorporated herein by reference, discloses a method and system for providing interactive controls using interactive video animation software for use in conjunction with content provided by a lodging entertainment system are disclosed. The lodging entertainment system includes a head end with a digital content server and a plurality of guest terminals connected by a distribution system. A display of interactive controls is transmitted with the content from the head end to a guest terminal. This preferably occurs in response to pressing a key on a remote control at the guest terminal. Then, interactive control selection data representing the interactive control selected by a guest is transmitted from the guest terminal to the head end. After processing the interactive control selection data at the head end, transmission of the content from the head end to the guest terminal is adjusted in accordance with the interactive control selected by the guest.

U.S. Patent Publication No. 2010/0257550 (Louis P. Slothouber, et al.), the entire disclosure of which is incorporated herein by reference, discloses an invention which comprises a system for and method of enhancing video advertising with interactive content in accordance with exemplary embodiments may include receiving non-interactive video advertisement data and advertisement order data associated with the non-interactive video advertisement data, generating interactive content data associated with the non-interactive video advertisement data, embedding, in the non-interactive video advertisement data, the interactive content data, and transmitting, to an ad server component of an ad system, the non-interactive video advertisement data and the embedded interactive content data for transmission to one or more end user devices.

U.S. Patent Publication No. 2011/0295667 (David Butler), the entire disclosure of which is incorporated herein by reference, discloses a system and computerized process for interactive display of advertisements is contemplated. The computerized process is embodied by online software that enables end users to voluntarily view and interact with an advertisement. Incentives may be offered for interacting with the advertisement. The incentives may relate to data transmission parameters such as data transmission rate. The incentives may be based on a monitored level of interaction by a user with the advertisement. Upon acceptance and/or interaction with the advertisement the transmission rate of the file may be increased up to the limit of the bandwidth otherwise available to the user.

This invention improves on the deficiencies of the prior art and provides an interactivity platform for multimedia transmission, broadcast TV, cable, radio, and live events.

### PURPOSES AND SUMMARY OF THE INVENTION

The invention is an interactivity platform for multimedia transmission, broadcast TV, cable, radio, and live events.

Therefore, one purpose of this invention is to provide a cost effective interactivity platform for multimedia transmission, broadcast TV, cable, radio, and live events.

Another purpose of this invention is to provide an interactive program between a provider and a participant utilizing an event.

Yet another purpose of this invention is to provide an interactive program between an event provider and a participant utilizing an event including the participant's input in response to a challenge from the event provider.

Still yet another purpose of this invention is to provide a novel reward and compensation system for both the event provider and the participant, and where the participant could interact with the event provider as an individual or as a part of a group or posse.

Therefore, in one aspect this invention comprises an apparatus for providing an interaction using an event or venue over a network comprising:

(a) at least one data center connected to said network, said data center comprising a database for processing said interaction;
(b) at least one player having at least one first digital device connected to said network;
(c) at least one watcher having at least one second digital device connected to said network;
(d) said at least one watcher generating at least one challenge over said network using said at least one second digital device;
(e) said at least one player generating a response to said at least one challenge from said watcher over said network using said at least one first digital device; and
(f) said at least one data center having at least one means to process said at least one challenge and said response to said challenge.

In another aspect this invention comprises a method for providing an interaction using an event or venue over a network comprising:

(a) connecting at least one data center to said network, said data center comprising a database for processing said interaction;
(b) connecting at least one player having at least one first digital device to said network;
(c) connecting at least one watcher having at least one second digital device to said network;
(d) said at least one watcher generating at least one challenge using said at least one second digital device and transmitting said at least one challenge over said network;
(e) said at least one player generating a response to said at least one challenge from said watcher over said network using said at least one first digital device; and
(f) said at least one data center having at least one means to process said at least one challenge and said response to said challenge.

In yet another aspect this invention comprises a program storage device readable by machine, tangibly embodying a program of instructions executable by the machine to perform method steps for providing an interaction using an event or venue over a network, the method steps comprising:

(a) connecting at least one data center to said network, said data center comprising a database for processing said interaction;
(b) connecting at least one player having at least one first digital device to said network;
(c) connecting at least one watcher having at least one second digital device to said network;
(d) said at least one watcher generating at least one challenge using said at least one second digital device and transmitting said at least one challenge over said network;
(e) said at least one player generating a response to said at least one challenge from said watcher over said network using said at least one first digital device; and
(f) said at least one data center having at least one means to process said at least one challenge and said response to said challenge.

In still yet another aspect this invention comprises a system for providing an interaction using an event or venue over a network comprising:

(a) at least one data center connected to said network, said data center comprising a database for processing said interaction;
(b) at least one group of players, and wherein at least one player in said group of players having at least one first digital device connected to said network;
(c) at least one watcher having at least one second digital device connected to said network;
(d) said at least one watcher generating at least one challenge over said network using said at least one second digital device;
(e) at least one player from said at least one group of players generating a response to said at least one challenge from said watcher over said network using said at least one first digital device; and
(f) said at least one data center having at least one means to process said at least one challenge and said response to said challenge.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1, illustrates a platform overview of an interactive program between a provider and a participant utilizing an event according to a first embodiment of the invention.

FIG. 2, illustrates an overview of an interactive program between an event provider and a participant utilizing an event including the participant's input in response to a challenge from the event provider according to a second embodiment of the invention.

FIG. 3, illustrates an overview of an interactive program between an event provider and a participant utilizing an event utilizing a smart phone with an administrative functions and data base connections according to a third embodiment of the invention.

FIG. 4, illustrates an overview of an interactive program between an event provider and a participant utilizing an event providing a redemption process of an award or reward according to a fourth embodiment of the invention.

FIG. 5, illustrates an overview of an interactive program between an event provider and a participant utilizing an event including a posse mechanisms and functionalities according to a fifth embodiment of the invention.

FIG. 6, illustrates an overview of a system administration area functions for the interactive program between an event provider and a participant utilizing an event according to the invention.

FIG. 7, illustrates an overview of a data base contents for the interactive program between an event provider and a participant utilizing an event according to the invention.

FIG. 8, illustrates an overview of an application boot and play sequence for the interactive program between an event provider and a participant utilizing an event according to the invention.

### DETAILED DESCRIPTION

The invention is directed to an interactivity platform for multimedia transmission, broadcast TV, cable, radio, and live events.

Over the last few decades, television interactivity has been limited to the most elementary of functionality . . . using the TV's remote to click on a list of enhanced channels that displayed detailed information on weather, news, sports and the occasional consumer product. The experience of actually “interacting” with broadcast or recorded programming was limited to using the TV remote's color coded a, b and c buttons or other pre-programmed keys.

Popsy has replaced this antiquated system with a new, robust platform that utilizes digital devices, such as, feature phones smart phones, cellular phones, PDAs, hand-held digital devices, etc. (device) as the main tools for conducting TV interactivity.

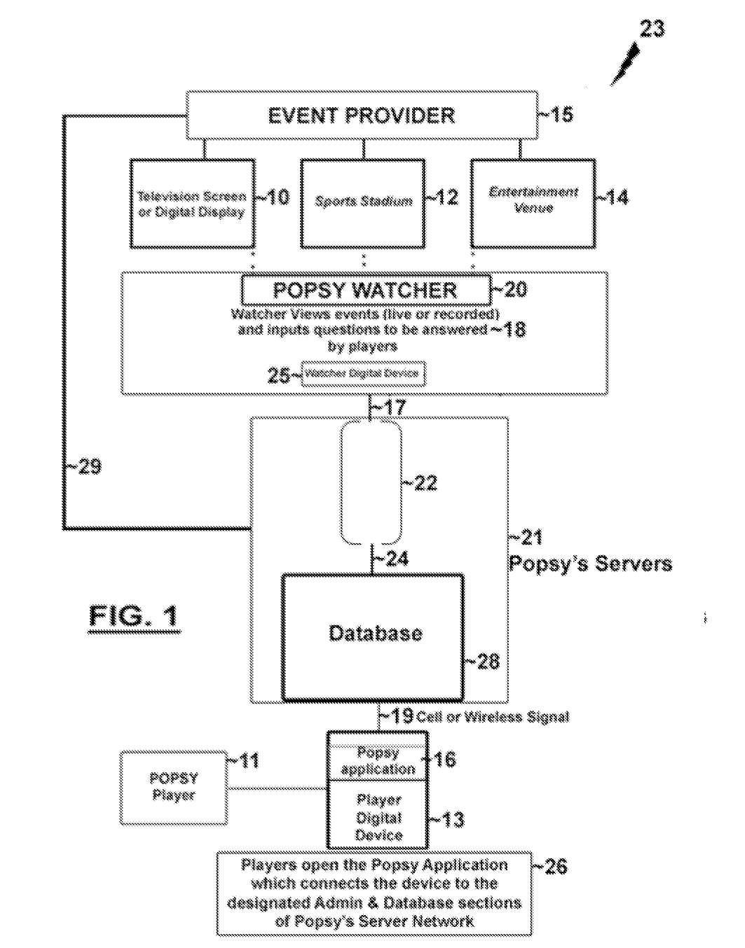

FIG. 1, illustrates a platform overview of an interactive program between a provider and a Popsy watcher 20, utilizing an event according to a first embodiment 23, of the invention. As shown in FIG. 1, a Popsy watcher 20, having a watcher's digital device 25, observes an event 10, 12, 14. The event could be on a television screen 10, or a digital display 10, or at a sports stadium 12, or at an entertainment venue 14, or in/at a similar such environment. The event 10, 12, 14, could be live or recorded. The event 10, 12, 14, could be observed by the Popsy watcher 20, directly at the venue of the event 10, 12, 14, or via his/her digital device 25. At least one event provider 15, interfaces between the Popsy watcher 20, and at least one event 10, 12, 14. The digital device 25, is electronically connected to a data base 28, via at least one digital interface 22, or a web interface 22. The data base 28, has at least one location for identifying and interacting with the player's device 13, or player's digital device 13. The Popsy watcher digital device 25, communicates with the digital interface 22, via a number of ways, such as for example, via the Internet 17, or via a virtual private network (VPN) 17, or a similar such network 17, that can provide telecommunication between the Popsy watcher's digital device 25, and the data base 28. Similarly, the digital interface 22, communicates with the data base 28, via at least one server interface 24 within Popsy's servers 21. It should be appreciated that the Popsy watcher 20, when accessing the digital interface 22, via the Watcher's digital device 25, the Watcher 20, is automatically connected via the digital device 25, to the designated administrator and database sections of the Popsy server network 21. Similarly, when the Watcher 20, is watching the event 10, 12, 14, the digital device 25, is automatically connected to the Popsy administrative section and which provides the input challenges and/or the questions 18. Optionally, the data base 28, could be made to communicate with the event provider 15, via communication means 29, so as to either synchronize the questions, or to influence the transmission being received by the Watcher's digital device 25, via the input being provided by the event provider 15. As stated in block 26, a Popsy player 11, or a player 11, would open the Popsy Application 16, which is residing in the player's digital device 13, and which would connect to the Popsy Servers 21 via cell or wireless signal 19, and to the designated administrator and database sections of the Popsy server network or data base 28.

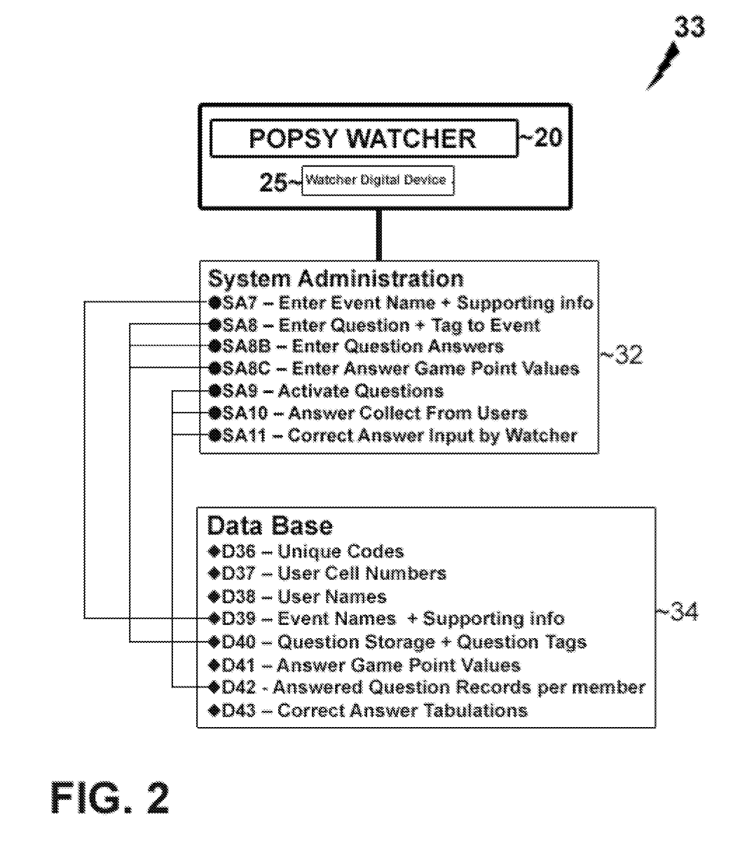

FIG. 2, illustrates an overview of an interactive program between an event provider 15, and a Popsy Watcher 20, utilizing an event 10, 12, 14, including the Popsy watcher's input in response to a challenge from the event provider 15, according to a second embodiment of the invention 33. As illustrated in FIG. 2, the Popsy Watcher 20, having the digital device 25, interacts with the database 34, via the administrative functions Popsy's servers 32. Some of the salient features that provide the interaction between the Popsy watcher 20, and with the system administration 32, and the data base 34, are presented in FIG. 2.

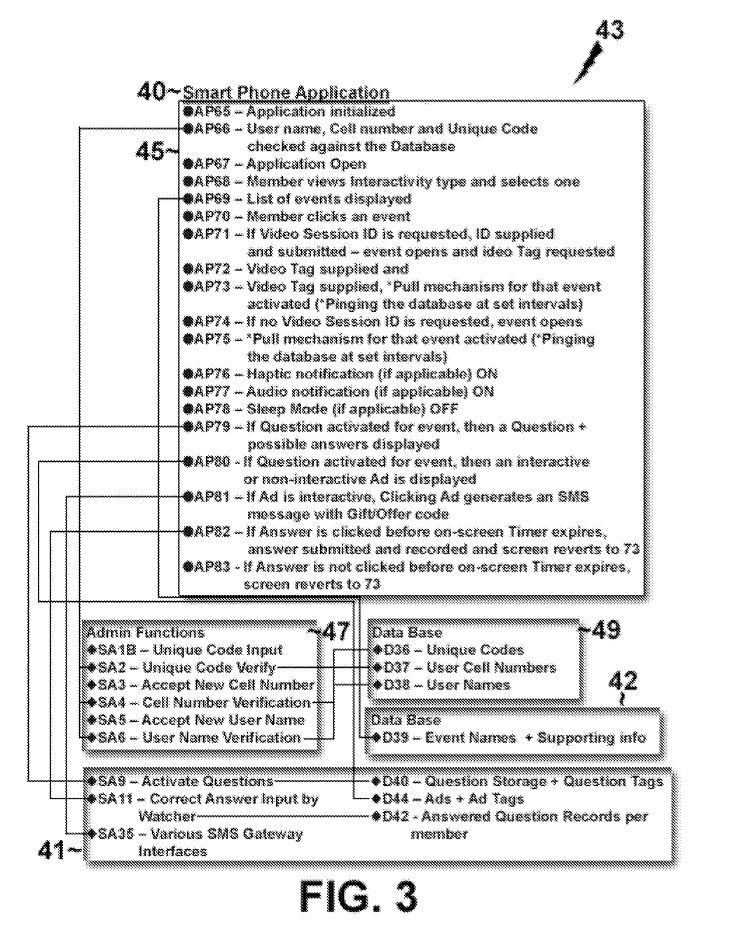

FIG. 3, illustrates an overview of an interactive program between an event provider 15, and a Popsy player 11, utilizing an event 10, 12, 14, utilizing a smart phone 13, utilizing the Popsy application 16, with a connection to Popsy administrative functions and data base according to a third embodiment of the invention 43. The third embodiment of the invention 43, uses a smart phone application 40, to illustrate the process, however, it should be understood that a similar such process can be used for other digital device(s). The sequence of actions upon application boot 45, the Popsy administrative function 47, and the data base connect 49, are illustrated in FIG. 3. Block 41, illustrates a response to specific issues originating in the sequence of actions upon application boot 45. Block 42, contains event information derived from the event type listing contained within the sequence of actions upon application boot 45.

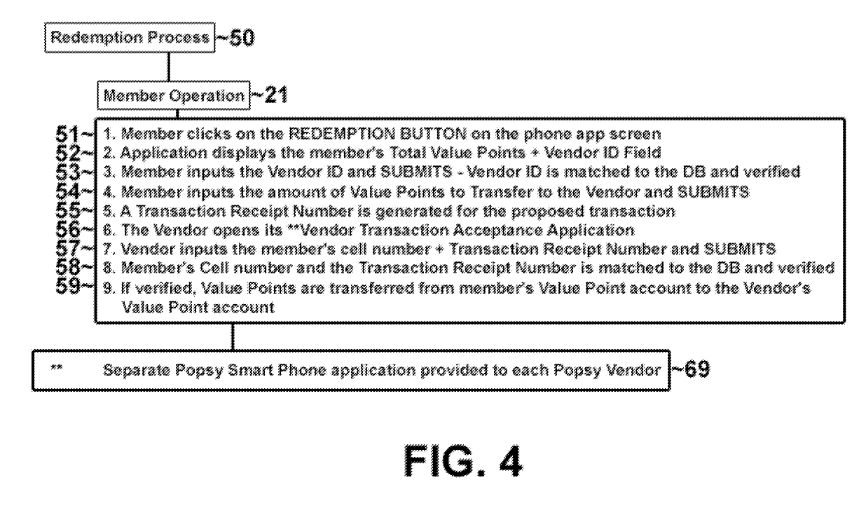

FIG. 4, illustrates an overview of an interactive program between an event provider 15, and a Popsy player 11, utilizing an event 10, 12, 14, providing a redemption process 50, of an award or reward, according to a fourth embodiment of the invention 50. For the redemption process 50, the member operation 21, would start at step 51, where the Popsy Player 11, would click on the redemption button on the Player digital device 13, such as, the phone app screen. At step 52, the application displays the member's total value points, along with a vendor ID (identification) Field. At step 53, the Popsy Player 11, inputs the vendor ID and presses on the submit button, and then the vendor ID is matched to the database 28, and also verified. At step 54, the Popsy Player 11, inputs the amount of value points to transfer to the vendor and presses the submit key. At step 55, a transaction receipt number is generated for the proposed transaction. At step 56, the vendor opens its vendor transaction acceptance application. At step 57, the vendor inputs the member's cell number or similar wireless contact information, along with the transaction receipt number and then presses the submit button. At step 58, the member's cell number and the transaction receipt number is matched to the data base 28, and also verified. At step 59, once the information has been verified the value points are then transferred from the Popsy Player's 11 value point account and into the vendor's value point account. It should be appreciated that separate Popsy smart phone application can be provided to each Popsy vendor via step 69.

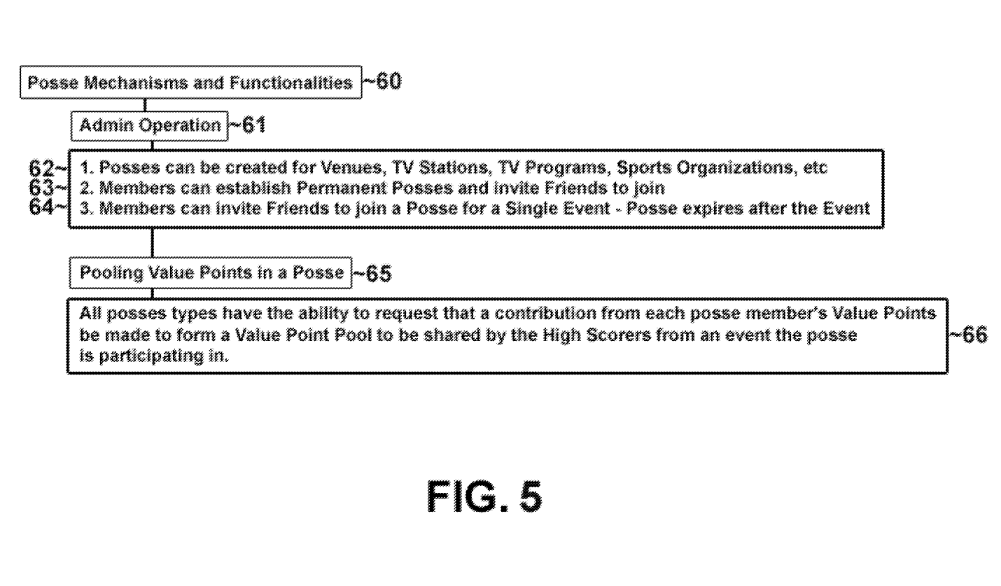

FIG. 5, illustrates an overview of an interactive program between an event provider 15, and a Popsy Player 11, utilizing an event 10, 12, 14, including a posse mechanisms and functionalities 60, according to a fifth embodiment of the invention 60. The posse mechanisms and functionalities 60, interacts with the admin operation 61, where at step 62, the posses can be created to venues, TV stations, TV programs, sports organizations, to name a few. At step 63, Popsy Players 11, can establish permanent posses for Popsy Players 11, and invite other Popsy Players 11, to join. At step 64, a Popsy Player 11, can also invited other Popsy Players 11, to join a posse for a single event 10, 12, 14, or a series of events 10, 12, 14, and after which the posse would expire after the event or the series of events. During this interaction the Popsy Players 11, could pool value points as represented at step 65. At step 66, a Popsy Player 11 who formed a posse has the ability to request that a contribution from each posse member's value points be made to form a value point pool to be shared by the high scorers from an event the posse 20, is participating in.

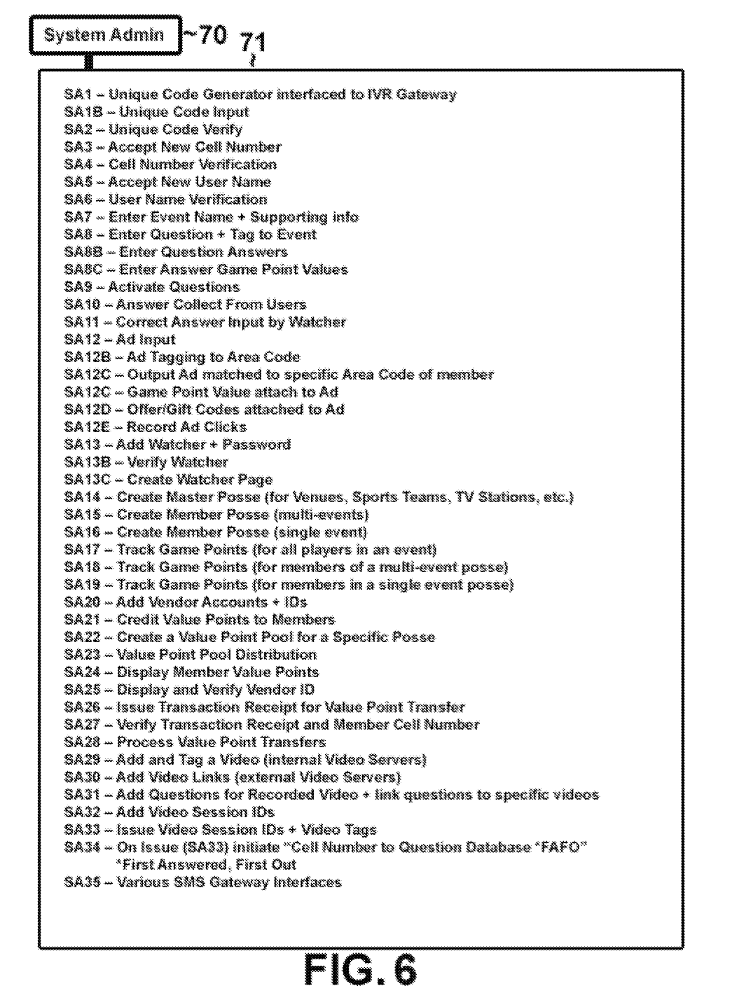

FIG. 6, illustrates an overview of a system administration area functions 70, for the interactive program between an event provider 15, a Popsy Watcher 20 and a Popsy Player 11, utilizing an event 10, 12, 14, according to the invention. Block 71, lists some of the common codes, and steps that are managed by the system administration area functions 70.

As discussed with reference to FIG. 6, the System Administration 70, could contain the following list of codes 71:
SA1—Unique Code Generator interfaced to IVR Gateway
SA1B—Unique Code Input
SA2—Unique Code Verify
SA3—Accept New Cell Number
SA4—Cell Number Verification
SA5—Accept New User Name
SA6—User Name Verification
SA7—Enter Event Name+Supporting info
SA8—Enter Question+Tag to Event
SA8B—Enter Question Answers
SA8C—Enter Answer Game Point Values
SA9—Activate Questions
SA10—Answer Collect From Users
SA11—Correct Answer Input by Watcher
SA12—Ad Input
SA12B—Ad Tagging to Area Code
SA12C—Output Ad matched to specific Area Code of member
SA12C—Game Point Value attach to Ad
SA12D—Offer/Gift Codes attached to Ad
SA12E—Record Ad Clicks
SA13—Add Watcher+Password
SA13B—Verify Watcher
SA13C—Create Watcher Page
SA14—Create Master Posse (for Venues, Sports Teams, TV Stations, etc.)
SA15—Create Member Posse (multi-events)
SA16—Create Member Posse (single event)
SA17—Track Game Points (for all players in an event)
SA18—Track Game Points (for members of a multi-event posse)
SA19—Track Game Points (for members in a single event posse)
SA20—Add Vendor Accounts+IDs
SA21—Credit Value Points to Members
SA22—Create a Value Point Pool for a Specific Posse
SA23—Value Point Pool Distribution
SA24—Display Member Value Points
SA25—Display and Verify Vendor ID
SA26—Issue Transaction Receipt for Value Point Transfer
SA27—Verify Transaction Receipt and Member Cell Number
SA28—Process Value Point Transfers
SA29—Add and Tag a Video (internal Video Servers)
SA30—Add Video Links (external Video Servers)
SA31—Add Questions for Recorded Video+link questions to specific videos
SA32—Add Video Session IDs
SA33—Issue Video Session IDs+Video Tags
SA34—On Issue (SA33) initiate “Cell Number to Question Database *FAFO”*First Answered, First Out
SA35—Various SMS Gateway Interfaces.

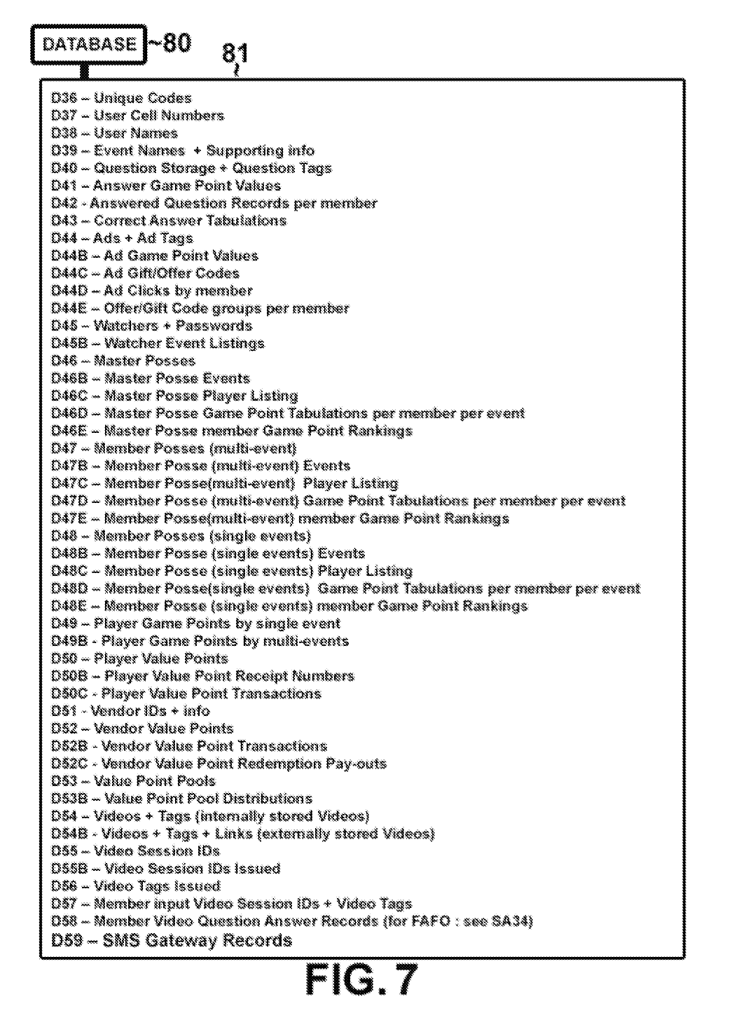

FIG. 7, illustrates an overview of a data base contents 81, for the interactive program between an event provider 15, a Popsy Watcher 20 and a Popsy Player 11 utilizing an event 10, 12, 14, according to the invention. The data base 80, contains the data base contents 81.

As discussed with reference to FIG. 7, the Data Base 80, could utilize the following list of codes 81:
D36—Unique Codes
D37—User Cell Numbers
D38—User Names
D39—Event Names+Supporting info
D40—Question Storage+Question Tags
D41—Answer Game Point Values
D42—Answered Question Records per member
D43—Correct Answer Tabulations
D44—Ads+Ad Tags
D44B—Ad Game Point Values
D44C—Ad Gift/Offer Codes
D44D—Ad Clicks by member
D44E—Offer/Gift Code groups per member
D45—Watchers+Passwords
D45B—Watcher Event Listings
D46—Master Posses
D46B—Master Posse Events
D46C—Master Posse Player Listing
D46D—Master Posse Game Point Tabulations per member per event
D46E—Master Posse member Game Point Rankings
D47—Member Posses (multi-event)
D47B—Member Posse (multi-event) Events
D47C—Member Posse (multi-event) Player Listing
D47D—Member Posse (multi-event) Game Points Tabulations per member per event
D47E—Member Posse (multi-event) member Game Point Rankings
D48—Member Posses (single events)
D48B—Member Posse (single events) Events
D48C—Member Posse (single events) Player Listing
D48D—Member Posse (single events) Game Point Tabulations per member per event
D48E—Member Posse (single events) member Game Point Rankings
D49—Player Game Points by single event
D49B—Player Game Points by multi-events
D50—Player Value Points
D50B—Player Value Point Receipt Numbers
D50C—Player Value Point Transactions
D51—Vendor IDs+info
D52—Vendor Value Points
D52B—Vendor Value Point Transactions
D52C—Vendor Value Point Redemption Pay-outs
D53—Value Point Pools
D53B—Value Point Pool Distributions
D54—Videos+Tags (internally stored Videos)
D54B—Videos+Tags+Links (externally stored Videos)
D55—Video Session IDs
D55B—Video Session IDs Issued
D56—Video Tags Issued
D57—Member input Video Session IDs+Video Tags
D58—Member Video Question Answer Records (for FAFO: see SA34)
D59—SMS Gateway Records.

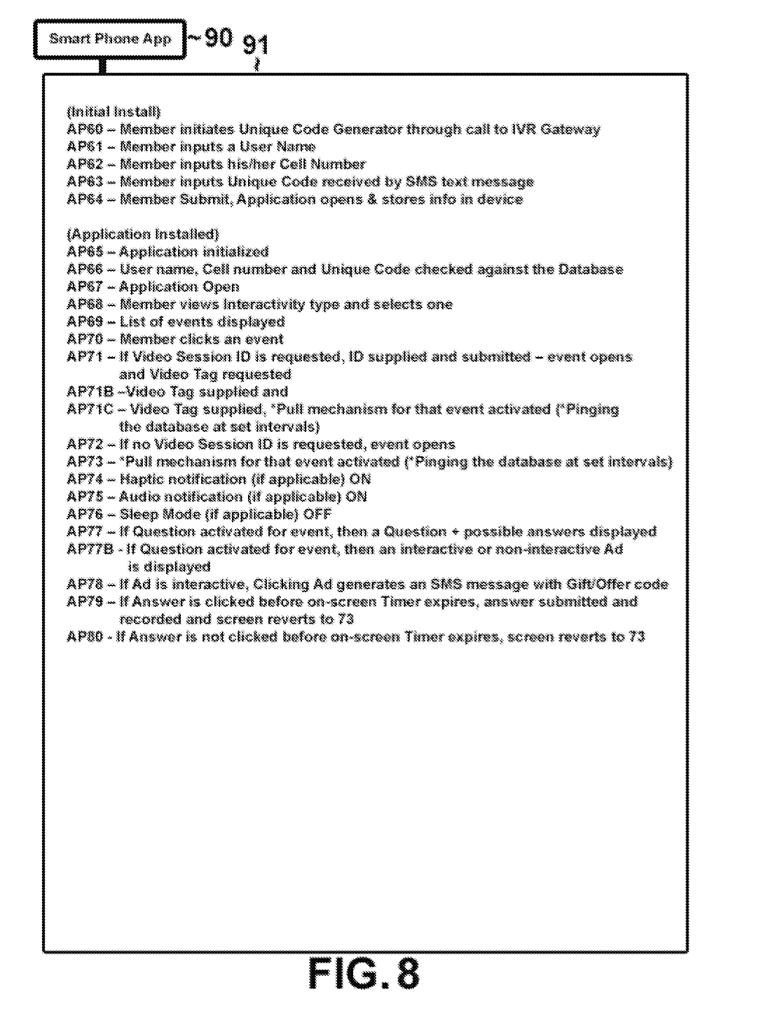

FIG. 8, illustrates an overview of an application boot and play sequence 91, for the interactive program between an event provider 15, and a Popsy Player 11, utilizing an event 10, 12, 14, according to the invention. The application boot and play sequence 91, has been illustrated for a smart phone application 90, however, it should be understood that an application boot and play sequence 91, would be similar in nature for another device 90, such as, for example, a personal digital assistant (PDA) 90, a computer 90, to name a few.

As discussed with reference to FIG. 8, for the smart phone application 90, the application for the boot and play sequence 91, could be selected from:

### (Initial Install)

AP60—Member initiates Unique Code Generator through call to IVR Gateway
AP61—Member inputs a User Name
AP62—Member inputs his/her Cell Number
AP63—Member inputs Unique Code received by SMS text message
AP64—Member Submit, Application opens & stores info in device

### (Application Installed)

AP65—Application initialized
AP66—User name, Cell number and Unique Code checked against the Database
AP67—Application Open
AP68—Member views Interactivity type and selects one
AP69—List of events displayed
AP70—Member clicks an event
AP71—If Video Session ID is requested, ID supplied and submitted—event opens and Video Tag requested
AP71B—Video Tag supplied and
AP71C—Video Tag supplied, *Pull mechanism for that event activated (*Pinging the database at set intervals)
AP72—If no Video Session ID is requested, event opens
AP73—*Pull mechanism for that event activated (*Pinging the database at set intervals)
AP74—Haptic notification (if applicable) ON
AP75—Audio notification (if applicable) ON
AP76—Sleep Mode (if applicable) OFF
AP77—If Question activated for event, then a Question+possible answers displayed
AP77B—If Question activated for event, then an interactive or non-interactive Ad is displayed
AP78—If Ad is interactive, Clicking Ad generates an SMS message with Gift/Offer code
AP79—If Answer is clicked before on-screen Timer expires, answer submitted and recorded and screen reverts to 73
AP80—If Answer is not clicked before on-screen Timer expires, screen reverts to 73.

As stated earlier Popsy creates interactive TV content by using “watchers” 20, who view live or recorded TV programming or similar such event 10, 12, 14, and input, to Popsy's database 28, an array of questions or challenges related to what they are watching. According to the type of programming, these questions are “activated” and pushed to a queue either at pre-determined times, random times or times determined by situations that occur in a broadcast. Broadcast or recorded events presented by Popsy each have their own queues of challenges or questions 18.

The Popsy Player 11 opens Popsy's application 16, on their device 13, and then navigates to an event 10, 12, 14, in a listing of events 10, 12, 14, and clicks or presses on the desired event 10, 12, 14. The Popsy Player 11, then proceeds to watch the corresponding broadcast on their TV screen 10, or watch a live event at 12 or 14. If a watcher 20 “activates” a question and pushes it to that event's queue, the Popsy Player's 11 phone 13, which pings that event's queue throughout the broadcast at set intervals, pulls the question to the Popsy Player's 11 device 13. The question or challenge 18, is then displayed on the Popsy Player's 11 device 13, with the following:

(1) A choice of answers with or without corresponding game point values.

(2) An advertisement—either interactive or not interactive.

(3) Other data that Popsy may or may not want to display on this screen.

(4) A timer may or may not be displayed that may limit the time allotted for a question or challenge to be answered.

Once an answer is submitted by the Popsy player 11, or participant 11, using the device 13, an advertising or additional challenge screen may or may not appear on the device 13. This screen can contain another ad that is or is not related to the ad in the question answered. Furthermore, this screen may contain a “bonus” opportunity for the Popsy Player 11, for additional game points, instant prizes provided by an advertiser, advertiser offers or coupons, Popsy rewards, etc. The Popsy Player 11, will click on one of a set of buttons or icons displayed on this page using his/her device 13. Once a button or icon is selected, the Popsy Player 11, is credited with the “bonus” associated with the button or icon clicked. The “bonus” page may or may not have a timing mechanism associated with it.

### Types of TV Broadcasts

The Popsy platform will be utilized, but will not be limited to, in the following types of TV broadcasts carried on cable or satellite TV systems:

(1) Live sports, drama, comedy, reality, or game shows.

(2) Recorded sports, drama, comedy, reality or game shows

Other Uses of Popsy's platform

Following are other types of media that Popsy will be used in:

(1) Internet streaming video, and/or audio programming.

(2) Live and/or recorded radio.

(3) Live venues, such as, stadiums, arenas, etc.

(4) Non-broadcast video, such as, movie theaters.

(5) Non-broadcast display of video or video clips displayed in venues other than a movie theater, such as, for example, the home, sports bar, to name a few.

### Scoring System

Game points are awarded for each correct answer submitted during an event 10, 12, 14. Game points may also be awarded through the “bonus” mechanism that may be employed for any given event. For each event 10, 12, 14, each participating Popsy Player's 11 game points are tallied and listed from high scorer to low scorer. If a Popsy Player 11 is in a group, that Popsy Player's 11 score is ranked and displayed in the scoring for that group. A Popsy Player 11 can be ranked by score in the overall pool of players that participate in an event and be ranked separately in the pool of players within a group. For instance, a player with a score of 11,550 game points may rank 35th in the overall pool of players for an event, yet rank 1st in a groups pool of players.

### User Groups (Posses)

Popsy's platform allows for, but is not limited to, the formation of the following types of user groups or posses:
(1) Member controlled—there are 2 types of user controlled groups:
   (a) Multi-event group—which is a group formed to play in multiple events.
   (b) Single-event group—which is a group formed to play in a specific event, after which, the group is dissolved.
(2) Venue controlled—this is a group of members that are specific to a venue, for example, a sports bar, a sports stadium, to name a few.
(3) Sports team controlled—these are groups that may be established by any level of organized sports team.
(4) TV show controlled—these are groups that may be established by a TV show.
(5) TV channel controlled—these are groups that may be established by a TV channel.

Any Popsy Player 11, may create a posse 11, and choose a name for that posse 11. For some applications whoever controls the posse (Posse Controller) (PC) 11, may invite other Popsy Players 11, to join. Once formed, the PC can send an invitation to each Popsy Player 11 of that posse, to participate in multiple or single Popsy events 10, 12, 14.

Scoring for posses, can be set for a single event 10, 12, 14, plurality of events 10, 12, 14, or all events that the Popsy Player 11 is participating in.

### Awards/Rewards

The high scorers of any event 10, 12, 14, can receive Value points from Popsy or from Popsy partners and advertisers. These Value points can be used to procure goods and/or services from Popsy, Popsy partners or Popsy advertisers. Popsy Players 11 will use Popsy's redemption system to facilitate such procurement.

### Other Uses of Value Points

Any Popsy Player 11 may contribute their Value points to any charity listed within the Popsy domain.

### Transfer of Popsy Points

Popsy provides a mechanism to transfer Value points to another Popsy player 11 or to a “pool” established within a Popsy posse 11. It should be appreciated that any one that controls a posse 11, may request that each Popsy player 11, in a posse 11, contribute Value points in order to participate in an event 10, 12, 14, that said posse, may be playing. As part of the invitation sent to each Popsy player 11 of the group 10, 12, 14, there is listed a pre-determined distribution of the pooled Value points. For instance, high scorer for an event 10, 12, 14, within the posse 11, could take all or the top 3 scorers and then split the Value points at a preset percentage rate or via similar other equitable distribution.

### Vendor Value Point Redemption Process

Value points can be redeemed at participating local business establishments. Each participating vendor D51, FIG. 7, or event provider 15, has a Popsy ID number. A module within the Popsy application 16, allows a Popsy Player 11, to see how many Value points that Popsy Player 11, has accumulated. The first step in the transaction is for the Popsy Player 11 to input the vendor's D51, FIG. 7, ID number in the appropriate field, then click submit. The vendor name appears on the screen along with how much value the members Value points hold for that specific establishment. The Popsy Player 11, then inputs how much value he/she wants to transfer to that establishment, then clicks submit, after which a transaction number D50B, FIG. 7, appears on the Popsy Player's 11 digital device screen 13. At this point, the establishment opens its Popsy transaction application 69, FIG. 4, (provided separately from the member Popsy app). A screen appears prompting the vendor to input the Popsy Player's 11 cell number, along with the transaction number. Once done and submitted, a screen appears confirming the transaction and the transaction amount D52B, FIG. 7. This action transfers the appropriate amount of Value points from the Popsy Player's 11 account to the vendor's account, where they can be redeemed in cash. Currently there is no mechanism in place that allows Popsy Player's 11, to redeem their points for cash, only vendors are permitted to do so, however, as this invention evolves certain mechanisms might be in place to reward the participants in more than one ways.

The Popsy Player's 11 digital device 13, could be selected from a group comprising a cell phone, personal digital assistant, handheld electronic device, feature phone, computer, smart phone, to name a few.

The Popsy Watcher's 20 digital device 25, could be selected from a group comprising a cell phone, personal digital assistant, handheld electronic device, feature phone, computer, smart phone, to name a few.

It should be appreciated that the challenge 18, at the event or venue 10, 12, 14, could be generated by the Popsy watcher 20, in real time, or at a predetermined time, or at a random time.

The challenge 18, that is generated by the Popsy Watcher 20, could be a question relating to the event, trivia relating to the event, prediction relating to the event, outcome relating to the event, a predictive challenge, a recall challenge, a recall challenge relating to the event, voting, polling, opinions, or a combination thereof, to name a few.

The challenge 18, that is generated by the Popsy Watcher 20, during the period could be selected from a group comprising a period of inactivity, halftime, short break, intermission, advertisement break, a supplement to an advertisement, at a crucial juncture of the event, to name a few.

The event 10, 12, 14, itself could be selected from a group comprising a live event, recorded event, concert, recital, tour, stage, musical play, sports event, conference, symposium, showcase, comedy revue, screening, exhibition, demonstration, opening, travel, skit, tournament, speech, convention, address, seminar, class, lecture, sermon, radio, audio transmission, video transmission, wireless broadcast, cable broadcast, television broadcast, digital broadcast, to name a few.

The at least one data center having the at least one means to process the at least one challenge and the response to the challenge generates at least one of, award, reward, prize, bonus, challenge, redemption offer, for the at least one Popsy player 11.

The invention also allows one to utilize the information gathered during an event 10, 12, 14, from the Popsy Watcher 20, generating one or more challenges 18, and those challenges being responded to by one or more Popsy Players 11, using the at least one data center having the at least one means to process the at least one challenge 18, and the response to the challenge to generate at least one of, feedback for promoters, feedback for sponsors, feedback for advertisers, feedback for organizers of said event, to name a few.

This invention utilizes push-pull technology. The push-pull technology could be utilized in either real time or at a predetermined time or randomly. The interaction between the member operation of the Smart Phone Application 40, FIG. 3, and the event provider 15, for the question or challenge 18, could be initiated by using haptic trigger, audio trigger, visual trigger, or a combination thereof.

The invention utilizing predictive challenges, recall challenges, trivia challenges, voting, polling, opinions, or a combination thereof. Upon completion of the challenge 18, the Popsy Player 11, is provided with rewards, awards, prizes, bonuses, challenges, and other redemption offers. This interaction also provides a feedback to promoters, sponsors, advertisers, organizers, event providers, to name a few.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An apparatus for providing an interaction using an event or venue over a network comprising:
(a) at least one data center connected to said network, said data center comprising a database for processing said interaction;
(b) at least one player having at least one first digital device connected to said network;
(c) at least one watcher having at least one second digital device connected to said network;
(d) said at least one watcher generating at least one challenge over said network using said at least one second digital device;
(e) said at least one player generating a response to said at least one challenge from said watcher over said network using said at least one first digital device; and
(f) said at least one data center having at least one means to process said at least one challenge and said response to said challenge.

2. The apparatus for providing an interaction using an event or venue over a network of claim 1, wherein said first digital device is selected from a group consisting of cell phone, personal digital assistant, handheld electronic device, feature phone, computer, and smart phone.

3. The apparatus for providing an interaction using an event or venue over a network of claim 1, wherein said second digital device is selected from a group consisting of cell phone, personal digital assistant, handheld electronic device, feature phone, computer, and smart phone.

4. The apparatus for providing an interaction using an event or venue over a network of claim 1, wherein said challenge is generated by said at least one watcher in at least one of real time, at a predetermined time, or at a random time.

5. The apparatus for providing an interaction using an event or venue over a network of claim 1, wherein said challenge that is generated by said at least one watcher is at least one of, question relating to said event, trivia relating to said event, prediction relating to said event, outcome relating to said event, a predictive challenge, a recall challenge, a recall challenge relating to said event, voting, polling, opinions, or a combination thereof.

6. The apparatus for providing an interaction using an event or venue over a network of claim 1, wherein said challenge that is generated by said at least one watcher is during a period selected from a group consisting of period of inactivity, halftime, short break, intermission, advertisement break, a supplement to an advertisement, and at a crucial juncture of said event.

7. The apparatus for providing an interaction using an event or venue over a network of claim 1, wherein said event is selected from a group consisting of live event, recorded event, concert, recital, tour, stage, musical play, sports event, conference, symposium, showcase, comedy revue, screening, exhibition, demonstration, opening, travel, skit, tournament, speech, convention, address, seminar, class, lecture, sermon, radio, audio transmission, video transmission, wireless broadcast, cable broadcast, television broadcast, and digital broadcast.

8. The apparatus for providing an interaction using an event or venue over a network of claim 1, wherein said at least one data center having said at least one means to process said at least one challenge and said response to said challenge generates at least one of, award, reward, prize, bonus, challenge, redemption offer, for said at least one player.

9. The apparatus for providing an interaction using an event or venue over a network of claim 1, wherein said at least one data center having said at least one means to process said at least one challenge and said response to said challenge generates at least one of, feedback for promoters, feedback for sponsors, feedback for advertisers, or feedback for organizers of said event.

10. A method for providing an interaction using an event or venue over a network comprising:
(a) connecting at least one data center to said network, said data center comprising a database for processing said interaction;
(b) connecting at least one player having at least one first digital device to said network;
(c) connecting at least one watcher having at least one second digital device to said network;
(d) said at least one watcher generating at least one challenge using said at least one second digital device and transmitting said at least one challenge over said network;
(e) said at least one player generating a response to said at least one challenge from said watcher over said network using said at least one first digital device; and
(f) said at least one data center having at least one means to process said at least one challenge and said response to said challenge.

11. The method for providing an interaction using an event or venue over a network of claim 10, wherein said first digital device is selected from a group consisting of cell phone, personal digital assistant, handheld electronic device, feature phone, computer, and smart phone.

12. The method for providing an interaction using an event or venue over a network of claim 10, wherein said second digital device is selected from a group consisting of cell phone, personal digital assistant, handheld electronic device, feature phone, computer, and smart phone.

13. The method for providing an interaction using an event or venue over a network of claim 10, wherein said challenge is generated by said at least one watcher in at least one of real time, at a predetermined time, or at a random time.

14. The method for providing an interaction using an event or venue over a network of claim 10, wherein said challenge that is generated by said at least one watcher is at least one of, question relating to said event, trivia relating to said event, prediction relating to said event, outcome relating to said event, a predictive challenge, a recall challenge, a recall challenge relating to said event, voting, polling, opinions, or a combination thereof.

15. The method for providing an interaction using an event or venue over a network of claim 10, wherein said challenge that is generated by said at least one watcher is during a period selected from a group consisting of period of inactivity, halftime, short break, intermission, advertisement break, a supplement to an advertisement, and at a crucial juncture of said event.

16. The method for providing an interaction using an event or venue over a network of claim 10, wherein said event is selected from a group consisting of live event, recorded event, concert, recital, tour, stage; musical play, sports event, conference, symposium, showcase, comedy revue, screening, exhibition, demonstration, opening, travel, skit, tournament, speech, convention, address, seminar, class, lecture, sermon, radio, audio transmission, video transmission, wireless broadcast, cable broadcast, television broadcast, and digital broadcast.

17. The method for providing an interaction using an event or venue over a network of claim 10, wherein said at least one data center having said at least one means to process said at least one challenge and said response to said challenge generates at least one of, award, reward, prize, bonus, challenge, redemption offer, for said at least one player.

18. The method for providing an interaction using an event or venue over a network of claim 10, wherein said at least one data center having said at least one means to process said at least one challenge and said response to said challenge generates at least one of, feedback for promoters, feedback for sponsors, feedback for advertisers, or feedback for organizers of said event.

19. A program storage device readable by machine, tangibly embodying a program of instructions executable by the machine to perform method steps for providing an interaction using an event or venue over a network, the method steps comprising:
(a) connecting at least one data center to said network, said data center comprising a database for processing said interaction;
(b) connecting at least one player having at least one first digital device to said network;
(c) connecting at least one watcher having at least one second digital device to said network;
(d) said at least one watcher generating at least one challenge using said at least one second digital device and transmitting said at least one challenge over said network;
(e) said at least one player generating a response to said at least one challenge from said watcher over said network using said at least one first digital device; and
(f) said at least one data center having at least one means to process said at least one challenge and said response to said challenge.

20. A system for providing an interaction using an event or venue over a network comprising:
(a) at least one data center connected to said network, said data center comprising a database for processing said interaction;
(b) at least one group of players, and wherein at least one player in said group of players having at least one first digital device connected to said network;
(c) at least one watcher having at least one second digital device connected to said network;
(d) said at least one watcher generating at least one challenge over said network using said at least one second digital device;
(e) at least one player from said at least one group of players generating a response to said at least one challenge from said watcher over said network using said at least one first digital device; and
(f) said at least one data center having at least one means to process said at least one challenge and said response to said challenge.
